(19) United States
(12) Patent Application Publication
(10) Pub. No.: US 2025/0161155 A1
(43) Pub. Date: May 22, 2025

(54) ON-DEMAND REAL-TIME FILLABLE AND DRAINABLE SPA

(71) Applicant: LPI Inc., Johnson City, TN (US)

(72) Inventor: David E. Hatley, Johnson City, TN (US)

(21) Appl. No.: 18/937,008

(22) Filed: Nov. 4, 2024

Related U.S. Application Data
(60) Provisional application No. 63/547,332, filed on Nov. 3, 2023.
(60) Provisional application No. 63/616,553, filed on Dec. 30, 2023.

(51) Int. Cl. A61H 33/00

(52) U.S. Cl. CPC A61H 33/0087; A61H 33/0095; A61H 33/601; A61H 33/6068; A61H 2201/5007; A61H 2201/5058; A61H 2201/5097

(57) ABSTRACT

A spa system is provided. A tankless water heater is connected to a water supply line providing water to the tankless water heater and a hot water line for providing heated water from the tankless water heater to a tub. A drain line is connected to the tub for draining water from the tub. A programmable controller operable in a plurality of modes comprising a fill mode in which a tub fill valve in the hot water line is activated to release water to the tub and a drain mode in which a tub drain valve in the drain line is activated to release water from the tub.

### CROSS-REFERENCE TO RELATED APPLICATIONS

This application claims the benefit of U.S. Provisional Patent Application Ser. Nos. 63/547,332 filed Nov. 3, 2023 and 63/616,553 filed Dec. 30, 2023, which are hereby incorporated by reference in their entirety.

### FIELD

This disclosure relates to spas and hot tubs.

### BACKGROUND

Although the medical benefits of spas and hot tubs are well known, the water in spas and hot tubs must be sanitized/disinfected, primarily through the use of chlorination. Additionally, spas and hot tubs are filled with cold water that subsequently must be heated. Currently, consumers initially fill a spa or hot tub with cold water and maintain the water through the use of chemicals (e.g., chlorine) and equipment (e.g., filters and salt cells if needed) while accruing additional electricity costs such as those to circulate and initially heat and keep the body of water heated to designated temperatures.

### SUMMARY

According to one aspect of the disclosed subject matter, a spa system is provided. A tankless water heater is connected to a water supply line providing water to the tankless water heater and a hot water line for providing heated water from the tankless water heater to a tub. A drain line is connected to the tub for draining water from the tub. A programmable controller operable in a plurality of modes comprising a fill mode in which a tub fill valve in the hot water line is activated to release water to the tub and a drain mode in which a tub drain valve in the drain line is activated to release water from the tub.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGURES and detailed description. It is intended that all such additional systems, methods, features and advantages that are included within this description, be within the scope of any claims.

### BRIEF DESCRIPTION OF THE FIGURES

The features, natures, and advantages of the disclosed subject matter may become more apparent from the detailed description set forth below when taken in conjunction with the drawings in which like reference numerals indicate like features.

FIG. 1 is a diagram of a spa system in accordance with the disclosed subject matter showing tankless water heater 2 mounted to a structure.

FIG. 2 is a diagram of the spa system of FIG. 1 and showing a controller.

FIG. 3 is a diagram of the spa system of FIG. 2 and showing a temperature control.

FIG. 4 is a diagram of a spa system showing electronic apparatus and water control component details of an embodiment of the disclosed solution enclosed in the spa housing.

FIG. 5 is a diagram of the spa system showing apparatus electronic and water control component details of an embodiment of the disclosed solution enclosed in the spa housing.

FIGS. 6A and 6B show embodiments of an on-demand real-time fillable spa system having water flow pressure reducers for temperature and tub fill rate control.

FIG. 7 is a diagram of the spa system of FIGS. 6A and 6B having water flow pressure reducers for temperature control.

### DESCRIPTION

The following description is not to be taken in a limiting sense, but is made for the purpose of describing the general principles of the present disclosure. The scope of the present disclosure should be determined with reference to the claims. The features and advantages of the embodiments will be more readily appreciated when considered in conjunction with the accompanying figures and drawings. Exemplary embodiments of the present disclosure may be illustrated in the drawings, like elements being used to refer to like and corresponding parts of the various drawings. The dimensions of drawings provided are not shown to scale.

The present application provides an innovative system for an on-demand real-time refillable and drainable spa system allowing users to enjoy fresh and non-chlorinated heated water. This disclosure details and provides designs, structures, and methods for filling and draining spas and hot tubs with heated water on-demand and in real-time. The present disclosure provides an innovative solution that eliminates both the need to maintain spa water with chemicals, often harsh, and the heating and circulation costs associated with maintaining spa temperature while not in use.

Advantageous embodiments include the ability to fill a spa from a tankless water heater using a remote device such as a phone to over 100 degrees Fahrenheit in less than an hour, regulate water temperature before it enters the spa tub, and drain the spa after use using a remote device such as a phone.

Spa and hot tub systems commonly have a tub (i.e., a basin) for holding heated water a user may sit in, a circulation system having water jets, pumps, and heating elements for circulating and heating water, an electrical controller controlling the circulation system, and an exterior spa case housing enclosing the tub and the circulation system. Known spa system components including a tub, circulation system, a controller, and an exterior spa case housing are shown in detail in U.S. Pat. No. 7,712,161 issued May 11, 2010 by Reynolds which is hereby incorporated by reference in its entirety.

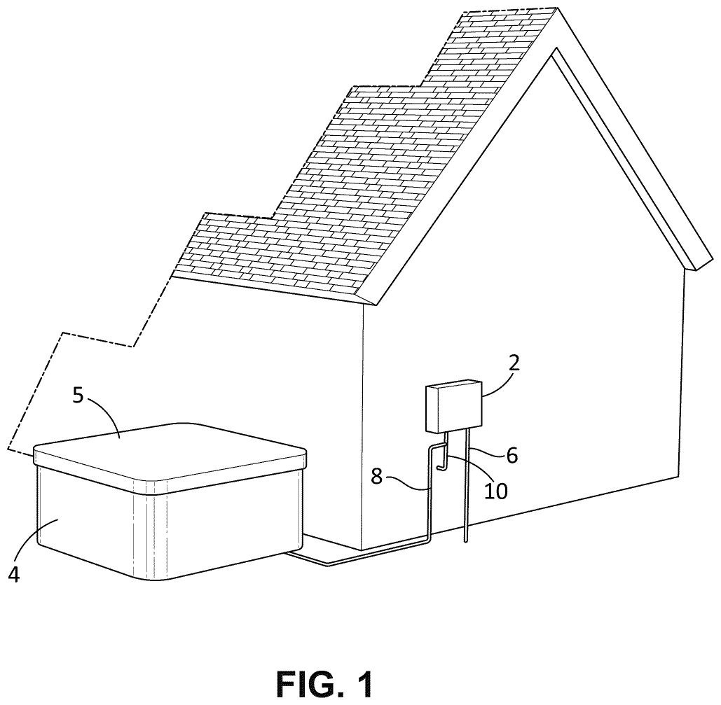

FIG. 1 is a diagram of a spa system in accordance with the disclosed subject matter showing tankless water heater 2 mounted to a structure such as a home, an exterior view of spa 4 showing an exterior spa case housing enclosing the spa tub for holding heated water and spa circulation system, and spa cover 5 covering the top of the spa tub. Water supply line 6 provides water to tankless water heater 2 (e.g., water from a home water service line to the tankless water heater) and hot water line 8 provides heated water from tankless water heater 2 to spa 4 which may go directly into and fill the spa tub via hot water line 8. Optional water line 10 may provide heated water for additional use. The tankless water heater of the present application may be mounted in a protectable mount on a home, installed as a stand alone structure such as within a storage box, or integrated with or housed within the exterior spa case housing.

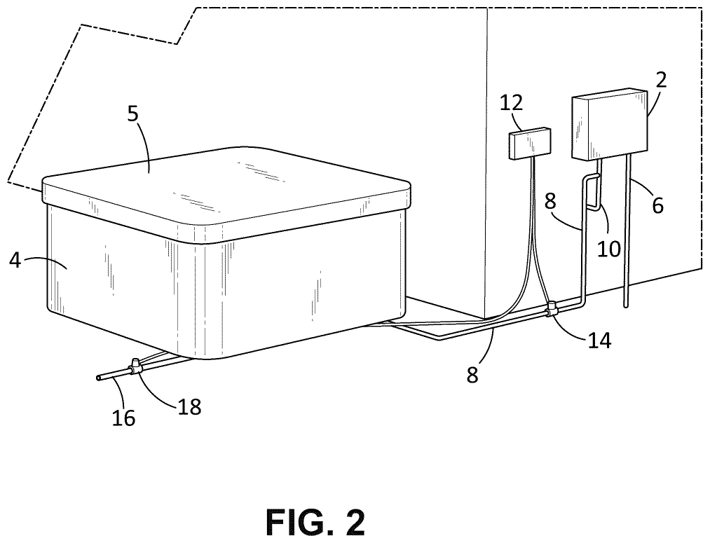

FIG. 2 is a diagram of the spa system of FIG. 1 and showing controller 12 controlling tub fill valve 14 (e.g., a motorized inline ball valve) in hot water line 8 and controlling tub drain valve 18 (e.g., an inline solenoid valve) in drain line 16. Controller 12 is shown mounted to a structure (e.g., a home or house) next to tankless water heater 2. Controller 12 may be directly instructed by a user via an instruction panel or may be a network or wireless enabled controller (e.g., WiFi) allowing a user to remotely instruct controller 12 via a mobile application, for example to allow for instruction on the smartphone of a user. Controller 12 is shown electrically connected and providing power to open and close tub fill valve 14 and tub drain valve 18. Tub fill valve 14 and tub drain valve 18 may be network or wireless (e.g., WiFi) enabled valves such as ball or solenoid valves allowing a user to directly instruct tub fill valve 14 and tub drain valve 18 via a controller mobile application, for example to allow for spa filling and draining control on a smartphone. When tub fill valve 14 is open, heated water from tankless water heater 2 fills the spa tub. When tub drain valve 14 is open, water is drained from the spa tub. Thus, the tub may be filled and drained using coordinated control of the fill water valve and the drain water valve, both operable via user control.

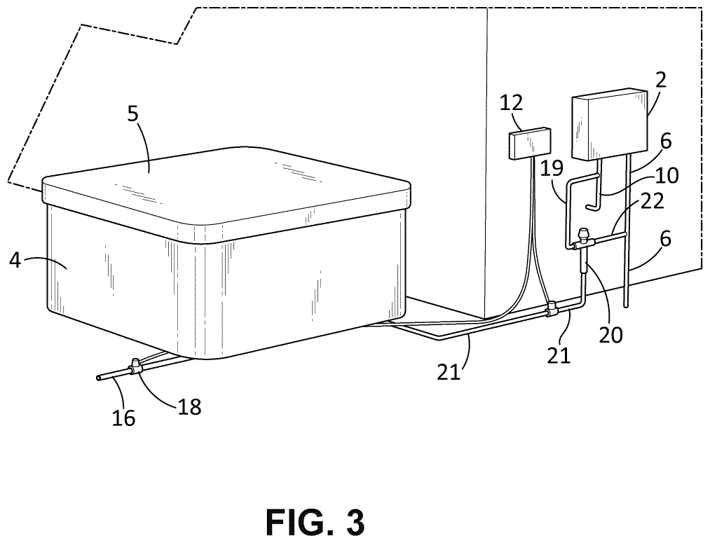

FIG. 3 is a diagram of the spa system of FIG. 2 and showing temperature control 20 (e.g., a thermostatic or digital mixing valve) controlling water temperature to mixed hot water line 21 by mixing water from hot water line 19 providing water from tankless water heater 2 and cold water line 22 providing water from water supply line 6 (e.g., from a home water service line to the temperature control 20).

The innovations of the present application have a electronic systems controller that may be independent or may be integrated into existing spa systems controllers such as traditional spa mounted controller panels adjusting water temperature and spa jets, often utilizing touch pad controls, and/or mobile application spa controllers via smartphone. Mobile applications may directly control the valves, such as network or wireless (e.g., WiFi) mobile application controlled ball and/or solenoid valves. The system may advantageously utilize components such as motorized ball valves or solenoid valves, float switches or water level sensors, a Wi-Fi controller, rocker switches, and touch pad controls to operate the system. The tankless water heater may advantageously be powered by natural gas or liquid propane gas and 120V power (e.g., 120V power provided by the controller).

The spa solution provided may be programmed or controlled to fill the spa with hot water from a tankless water heater at a given user desired interval. For example, the spa may fill once the user engages/starts the system start (e.g., via a WiFi controller). In an advantageous embodiment, the system starts with the user activating the system to fill the spa via a Wi-Fi app on a user device such as a phone and the controller or manually at the controller. A motorized ball valve or solenoid valve operated by the controller opens to fill the spa with hot water from a tankless water heater—when this fill valve is open to fill the spa tub with hot (heated) water the controller is in fill mode. The desired water fill level may be preset by a predetermined time according to water flow rate and/or a float switch or sensor at a desired fill level to activate the controller to close the fill water valve to stop tub filling (e.g., to avoid overfill). The tub fill sensor may be attached at the desired high water level of the tub, for example a water level sensor adhered to the shell on the fiberglass resin at the edge of the tub. A two system combination of a sensor and time based fill level provides enhanced safety control in the event of remote user control water overfill. The user may control the fill water valve to start or stop the water into the spa using the Wi-Fi app on the user device at any time (i.e., if more water or a partially full tub is desired).

A thermostatic mixing valve optionally controls the temperature of the water going into the spa based on user preference, for example 100 degrees Fahrenheit, by mixing the water from the water heater with ambient temperature water from a water service intake and may additionally limit the water temperature from being too hot for the end user (e.g., additional scald protection may be provided via a thermostatic scald protection valve inline with the hot water line providing heated water from the tankless water heater to the tub). Hot water may be considered water having a temperature at least 100 degrees Fahrenheit, however the hot and heated water as described herein may be any water that has been heated. Similarly, cold water as described herein is any water that has not been heated.

The spa solution may optionally utilize a float switch or water level sensor internally within the spa (e.g., spa tub) to engage a traditional spa circulation system at a designated water level to maintain or adjust to a desired temperature while the spa continues to fill. Once the spa is filled, the traditional spa system maintains or adjusts temperature and circulation.

After spa use, the end user is able to drain the spa manually or advantageously via a solenoid valve or motorized ball valve operated via a Wi-Fi app and controller. The user may initiate and control the drain valve to drain the water from the spa using the Wi-Fi app on the user device and the controller or on a spa mounted control panel at any time (i.e., if less water is desired)—when this drain valve is open to drain the spa tub of water the controller is in drain mode. The desired water drain level may be preset by a predetermined activation time according to water flow rate and may be automatically adjusted to a water drain level via a float switch or water level sensor at the desired water drain level (e.g, attached at a low/zero water level of the tub basin, for example a water level sensor adhered to the shell on the fiberglass resin at the floor of the tub) which may activate the controller to close the tub drain water valve on the tub drain line to stop tub draining. Advantageously, a discharging pump may be activated to drain the tub. A two system combination of a sensor and time based drain valve (and optional drain pump) activation provides enhanced safety control in the event of remote user control over water drain. The user may control the drain water valve and optional drain pump to start or stop the water draining from the spa using the Wi-Fi app on the user device at any time (i.e., if less water or a partially full tub is desired). Advantageously, because the drained water may be untreated and unchlorinated, for example standard water service water, this water may be repurposed and used to water lawns, plants, and gardens of the spa and hot tub user directly after discharge.

In a specific embodiment, the system may use a 4.3 GPM 100,000 BTU propane or natural gas tankless water heater set at 105 to 106 degrees Fahrenheit connected to a home water service line with ¾″ line (e.g., hose or PVC) having a 30 PSI inline water reducer for water supply and a ¾″ line (e.g., hose or PVC) for heated water output to fill a proximate 300 gallon spa or hot tub with water in the range of 102 to 104 degrees Fahrenheit in less than an hour.

In a specific embodiment, the system may utilize components such as a thermostatic mixing valve (e.g., a typical plumbing part such as a ¾″ PEX crimp MIXCAL 3-way adjustable thermostatic and pressure balanced mixing valve with check valve and gauge) to regulate temperature from the water heater and water service in (providing ambient temperature water), motorized ball valves (e.g., a motorized ball valve—¾ inch stainless steel electrical ball valve with full port, 9-24V AC/DC and 3 wire setup) to release water from the tankless water heater to fill the tub and to drain the tub, float switches and water level sensors, and Wi-Fi controller control system for filling and draining of the spa. These components may be integrated within the spa case/housing.

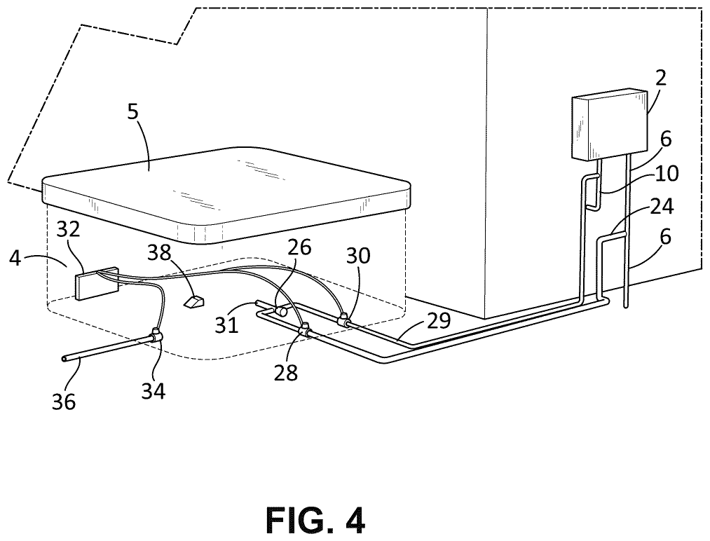

FIG. 4 is a diagram of a spa system showing electronic apparatus and water control component details of an embodiment of the disclosed solution enclosed in the spa housing. Temperature control 26 (e.g., a thermostatic mixing valve) controlling water temperature to mixed hot water line 31 by mixing water from hot water line 29 providing water from tankless water heater 2 and cold water line 24 providing water from water supply line 6. Controller 32 is shown electrically connected and providing power to hot water tub fill valve 30 and cold water tub fill valve 28 to fill the tub with water from tankless water heater 2 and water supply line 6. Controller 32 is shown electrically connected and providing power tub drain valve 34 on tub drain line 36 to drain water from the spa tub. Float switch 38 may be used to initiate the spa circulation system at the appropriate water fill level, for example to maintain the desired full tub water temperature.

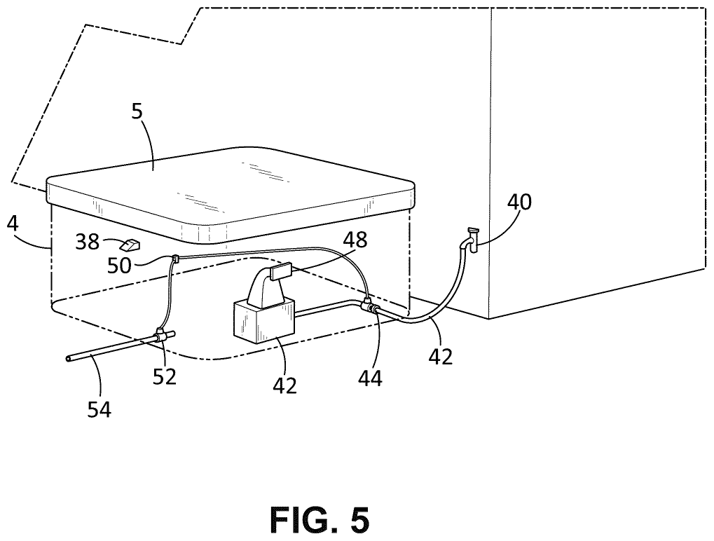

FIG. 5 is a diagram of the spa system showing apparatus electronic and water control component details of an embodiment of the disclosed solution enclosed in the spa housing. The tub is filled with heated water from tankless water heater 42 enclosed in the spa housing and having tankless water heater vent 48. Fill and drain switch 50 controls tub fill valve 44 (e.g., a motorized inline ball valve) in fill hose 46 (e.g, a garden hose) supplying water from traditional water outlet/hose bib 40 and controls tub drain valve 52 (e.g., a motorized inline ball valve) in water drain line 54.

FIG. 5 shows an embodiment of an on-demand real-time fillable spa system having an integrated tankless water heater enclosed in the spa housing. In an advantageous embodiment, the spa system fills the spa with hot water using an integrated tankless water heater at any given user desired interval. The spa may fill with water once the user engages the system via a start switch or via Wi-Fi. System initialization begins with the user activating the system to start spa fill via Wi-Fi and drain switch 50 or manually at the spa via a switch activating drain switch 50. Water fill valve 44 opens to flow water from hose 42 connected to an external traditional water source, such as home hose bib 40, through tankless water heater 42. The water is then heated via integrated tankless water heater 42 prior to filling the spa tub. The heated water then flows into the spa tub from integrated tankless water heater 42 to fill the spa tub via an integrated tankless water heater 42 to spa tub plumbing connection. The spa system advantageously may have a float switch or water level sensor internally to the spa tub to stop the water fill and engage a traditional spa circulation system at a designated water fill level within the spa. Once the spa is filled, the spa system may maintain temperature and circulation for example via a traditional spa temperature and circulation system. After use, the user may drain the spa via Wi-Fi and drain switch 50 or manually using a switch activating drain switch 50 to engage motorized ball valve 52 to release the water from the spa tub and drain the spa via spa water drain line 54 connected to the spa tub.

And while the water temperature output of modern tankless water heaters may often be set directly on the heaters themselves, tankless water heaters have limited temperature control and regulation outside of this on-heater adjustment. Advantageously, the present solution may provide a water regulator, for example a 30 PSI water flow regulator (e.g, 30 PSI water flow reducer inline with the home water service line), to regulate water flow to the heater and maintain a constant water heater output temperature. Increased water flow through the heater lowers the water heater output temperature and decreased water flow through the water heater increases the water heater output temperature. Thus, if water flow through the heater is decreased the water filling the spa may be higher (i.e. hotter) and if water flow through the heater is increased the water filling the spa may be lower (i.e., colder). By regulating water flow, the heater output water may be maintained at a constant and consistent temperature. In colder ambient weather temperatures, the temperature of the tankless heater may be easily changed (i.e., increased) to obtain an optimal 102 degrees Fahrenheit full water tub temperature, and in hotter ambient weather temperatures the temperature of the tankless heater may be easily changed (i.e., decreased) to obtain an optimal 102 degrees Fahrenheit full water tub temperature.

Spa and hot tub users generally enjoy and appreciate the benefits of filled tub water at a temperature in the range of 100 to 104 degrees Fahrenheit. From the tankless water heater to the tub some water temperature drop is expected, for example one to three degrees Fahrenheit. For example, depending on variables relating to the water line insulation, length of water travel (e.g., water line length), water flow, heater temperature setting, and the heater itself, to fill the tub with water having a temperature of 103 to 104 degrees Fahrenheit, a 30 PSI water reducer may be used to output water from the spa proximate tankless water heater set in the range of 105 to 106 degrees Fahrenheit.

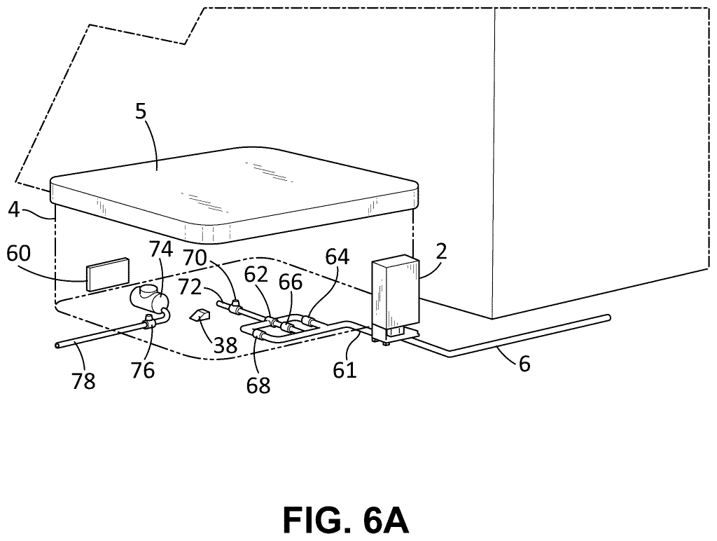

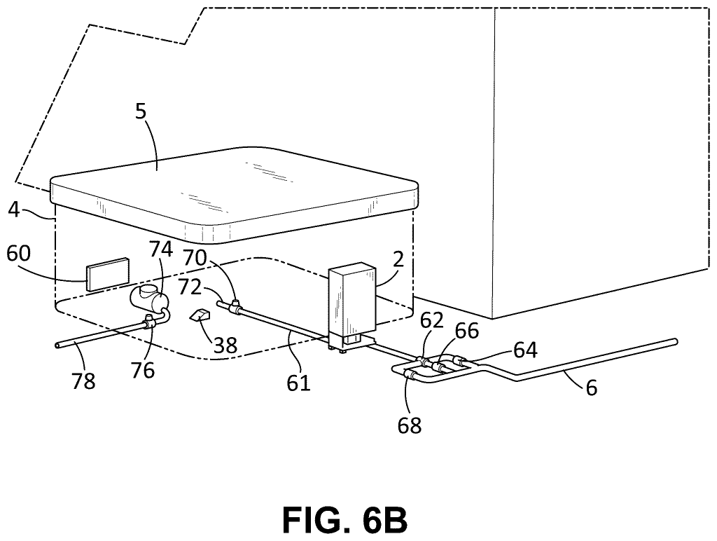

FIG. 6A shows an embodiment of an on-demand real-time fillable spa system having water flow pressure reducers for temperature and tub fill rate control inline after the flow of water from the tankless water heater. Differently sized reducers may control water flow based on valve selection to achieve desired tub fill water temperature at different fill rates. Water flow reducers 64, 66, and 68 each having different pressure reductions (e.g., 25 PSI, 30 PSI, and 35PSI, respectively) reduce the water flow from water supply line 6 through tankless water heater 2 to hot water line 61 thus adjusting the output water temperature from tankless water heater 2. Controller 60 controls hot water tub fill valve 70 and water flow regulator 62 (e.g., a three way valve such as a motorized three way diverter valve) to fill the tub via hot water fill line 72 with water from tankless water heater 2 and water supply line 6. Controller 60 controls tub drain pump 74 (e.g., an inline hot tub water drain/discharge pump activated for approximately twenty five minutes using a 2″ water line and ⅜″ air line tubing to discharge all the water in a 300 gallon tub) and tub drain valve 76 on tub drain line 78 to drain water from the spa tub.

FIG. 6B shows an embodiment of an on-demand real-time fillable spa system having water flow pressure reducers for temperature and tub fill rate control inline before the flow of water to the tankless water heater.

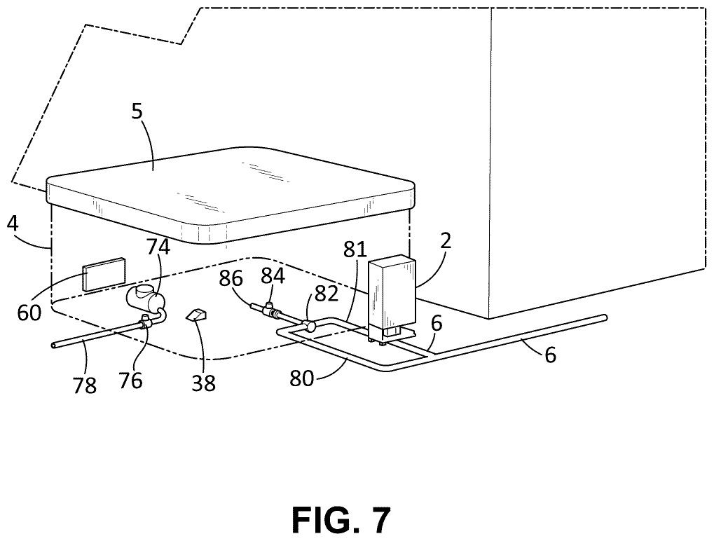

FIG. 7 is a diagram of the spa system of FIGS. 6A and 6B having water flow pressure reducers for temperature control. Temperature control 82 (e.g., a thermostatic mixing valve) controls water temperature to mixed hot water line 86 by mixing water from hot water line 81 providing water from tankless water heater 2 with cold water line 80 providing water from water supply line 6. Controller 60 controls hot water tub fill valve 84 to fill the tub with water from tankless water heater 2 and water supply line 6 through mixed hot water line 86. Controller 60 controls tub drain pump 74 (e.g., an inline hot tub water drain/discharge pump activated for approximately twenty five minutes using a 2″ water line and ⅜″ air line tubing to discharge all the water in a 300 gallon tub) and tub drain valve 76 on tub drain line 78 to drain water from the spa tub.

The foregoing description of the exemplary embodiments is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A spa system comprising:
a tub;
a tankless water heater is connected to a water supply line providing water to said tankless water heater and a hot water line for providing heated water from said tankless water heater to said tub;
a drain line is connected to said tub and draining water from said tub; and,
a programmable controller operable in a plurality of modes comprising:
a fill mode in which a tub fill valve in said hot water line is activated to release water to said tub;
a drain mode in which a tub drain valve in said drain line is activated to release water from said tub.

2. The spa system of claim 1, wherein said programmable controller further comprises a temperature control for adjusting the temperature of the water to said tub.

3. The spa system of claim 2, further comprising at least two water flow regulators regulating the flow of water through said tankless water heater.

4. The spa system of claim 3, wherein said at least two water flow regulators regulate the flow of water before water flow into said tankless water heater.

5. The spa system of claim 3, wherein said at least two water flow regulators regulate the flow of water after water flow into said tankless water heater.

6. The spa system of claim 2, further comprising a thermostatic mixing valve inline before water flow into said tub fill valve, said thermostatic mixing valve mixing heated water from said tankless water heater and water from said water supply line.

7. The spa system of claim 1, further comprising a drain pump connected to said drain line and activated in said drain mode.

8. The spa system of claim 1, wherein said fill mode is activated for a preset time.

9. The spa system of claim 1, wherein said fill mode is activated after initiated until said programmable controller receives a signal from a water fill sensor indicating the water level in said tub has reached a certain level.

10. The spa system of claim 1, wherein said drain mode is activated for a preset time.

11. The spa system of claim 1, wherein said drain mode is activated after initiated until said programmable controller receives a signal from a water drain sensor indicating the water level in said tub has reached a certain level.

12. The spa system of claim 1, wherein said programmable controller operable may be controlled via a wireless network.

13. A spa system comprising:
a tub;
a tankless water heater is connected to a water supply line providing water to said tankless water heater and a hot water line for providing heated water from said tankless water heater to said tub;
a drain line connected to said tub and draining water from said tub; and,
a programmable controller operable in a plurality of modes comprising:
a fill mode in which a tub fill valve in said hot water line is activated to release water to said tub, said fill mode activated after initiated until a first of said programmable controller receives a signal from a water fill sensor indicating the water level in said tub has reached a certain level or a preset time;
a drain mode in which a tub drain valve in said drain line is activated to release water from said tub.

14. The spa system of claim 13, wherein said drain mode is activated for a preset time.

15. The spa system of claim 13, wherein said drain mode is activated after initiated until said programmable controller receives a signal from a water drain sensor indicating the water level in said tub has reached a certain level.

16. The spa system of claim 13, further comprising at least two water flow regulators regulating the flow of water through said tankless water heater.

17. The spa system of claim 13, further comprising a thermostatic mixing valve inline before water flow into said tub fill valve, said thermostatic mixing valve mixing heated water from said tankless water heater and water from said water supply line.

18. The spa system of claim 13, wherein said programmable controller operable may be controlled via a wireless network.

19. A spa system comprising:
a tub;
a tankless water heater is connected to a water supply line providing water to said tankless water heater and a hot water line for providing heated water from said tankless water heater to said tub;
a drain line connected to said tub and draining water from said tub; and,
a programmable controller operable in a plurality of modes comprising:
a fill mode in which a tub fill valve in said hot water line is activated to release water to said tub, said fill mode activated after initiated until a first of said programmable controller receives a signal from a water fill sensor indicating the water level in said tub has reached a certain level or a preset time;
a drain mode in which a tub drain valve in said drain line is activated to release water from said tub, said drain mode activated after initiated until a first of said programmable controller receives a signal from a water drain sensor indicating the water level in said tub has reached a certain level or a preset time.

20. The spa system of claim 19, wherein said programmable controller operable may be controlled via a wireless network.
